(19) United States
(12) Patent Application Publication
(10) Pub. No.: US 2009/0007443 A1
(43) Pub. Date: Jan. 8, 2009

(54) Personal Razor Device

(76) Inventor: Joseph M. Cuocolo, JR., Wilmington, DE (US)

Correspondence Address: HARSHAW RESEARCH, INC., 210 W. TECUMSEH STREET, OTTAWA, KS, 66067, US

(21) Appl. No.: 11/774,046

(22) Filed: Jul. 6, 2007

(51) Int. Cl. B26B 21/00

(52) U.S. Cl. 30/526; 30/32

(57) ABSTRACT

A personal razor device includes a primary cutting head having a primary cutting member. A primary handle includes one end coupled to the primary cutting head. The razor device includes an auxiliary cutting member and an auxiliary handle coupled to the auxiliary cutting member. The auxiliary cutting member is removably coupled to the primary handle. In a first configuration, the auxiliary cutting member is positioned inside a hollow cavity defined by the primary handle whereas in a second configuration, the auxiliary cutting member is outside the primary handle. The primary and auxiliary handles may each include one of a protrusion and receiving element having complementary configurations. Interaction between these structures may selectively couple the primary and auxiliary handles together. These structures may be configured so that the auxiliary cutting member is adjacent a first end of the primary handle or adjacent a second end of the primary handle.

### BACKGROUND OF THE INVENTION

The present invention relates generally to personal razors and, more particularly, to a personal razor device that enables a user to shave larger areas with a primary razor cutting member and smaller, intricate areas with an auxiliary cutting member.

Personal razors are typically used by men for shaving the face. Razors of this type have developed significantly over the years such that they are able to provide a very close shave and enable a user to shave his face relatively quickly. Modern razors may be characterized by relatively large shaving members and multiple adjacent blades. However, large cutting members are less effective at shaving smaller, curved, or intricate areas such as the area beneath one's nose but above one's upper lip.

Various devices and designs have been proposed to combine a larger, traditional cutting member with a smaller cutting member in an effort to enable a person to shave large and small areas of a person's face. Although assumably effective for their intended purposes, the existing devices and proposals do not provide maximum convenience in deploying a smaller auxiliary cutting member relative to a primary cutting member or do not provide an efficient cutting blade configuration.

Therefore, it would be desirable to have a personal razor device having a primary cutting head connected to a primary handle for shaving large facial areas. Further, it would be desirable to have an auxiliary cutting head having an auxiliary cutting member that is connected to an auxiliary handle for shaving smaller, intricate facial areas. In addition, it is desirable to have a personal razor in which the auxiliary handle is removably coupled to the primary handle such that it may be removed when a user desires to shave with the auxiliary cutting member.

### SUMMARY OF THE INVENTION

A personal razor device according to the present invention includes a primary cutting head having a primary cutting member. It also includes a primary handle having one end coupled to the primary cutting head. The personal razor device includes an auxiliary cutting member and an auxiliary handle coupled to the auxiliary cutting member. The auxiliary cutting member is removably coupled to the primary handle. In a first configuration, the auxiliary cutting member is positioned inside a hollow cavity defined by the primary handle whereas in a second configuration, the auxiliary cutting member is outside the primary handle.

The primary handle and auxiliary handle may each include one of a protrusion and receiving element having complementary configurations. Interaction between these two structures may selectively couple the primary and auxiliary handles together. These structures may be configured so that the auxiliary cutting member is adjacent a first (upper) end of the primary handle or alternatively adjacent a second (lower) end of the primary handle.

In another embodiment, the primary and auxiliary handles are coupled together but not positioned one within the other. In other words, the two handle portions define a unitary handle. In still another embodiment, the auxiliary cutting member is movable between first (retracted) and second (extended) configurations by means of a slider button.

Therefore, a general object of this invention is to provide a personal razor device that enables a user to selectively shave large facial areas or smaller, intricate areas.

Another object of this invention is to provide a personal razor device, as aforesaid, in which an auxiliary handle is removably coupled to a primary handle for convenient storage or removable use.

Still another object of this invention is to provide a personal razor device, as aforesaid, in which the auxiliary handle includes an auxiliary cutter hidden within the primary handle in a storage configuration and exposed in a use configuration.

A further object of this invention is to provide a personal razor device, as aforesaid, that is user-friendly to use and inexpensive to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a personal razor device according to one embodiment of the present invention;

FIG. 1b is a perspective view of the razor device as in FIG. 1a with a portion of the primary handle removed;

FIG. 2 is a perspective view of the razor device as in FIG. 1a with the auxiliary cutting device in a separated configuration;

FIG. 3 is a perspective view of the razor device according to another embodiment in a separated configuration;

FIG. 4a is a side view of the razor device as in FIG. 1a;

FIG. 4b is a sectional view of the razor device taken along line 4b-4b of FIG. 4a;

FIG. 4c is an isolated view on an enlarged scale taken from FIG. 4b with a biasing member illustrated as a resilient member;

FIG. 4d is an isolated view of the razor device as in FIG. 4c with the biasing member illustrated as a spring;

FIG. 5a is a side view of the auxiliary cutting member of FIG. 2;

FIG. 5b is a perspective view of the auxiliary cutting member as in FIG. 5a;

FIG. 5c is a sectional view taken along line 5c-5c of FIG. 5a;

FIG. 6 is a perspective view of a razor device according to another embodiment of the present invention in a separated configuration;

FIG. 7a is a perspective view of a razor device according to still another embodiment of the present invention in a retracted configuration; and

FIG. 7b is another perspective view of the razor device as in FIG. 7a in an extended configuration.

### DESCRIPTION OF THE PREFERRED EMBODIMENT

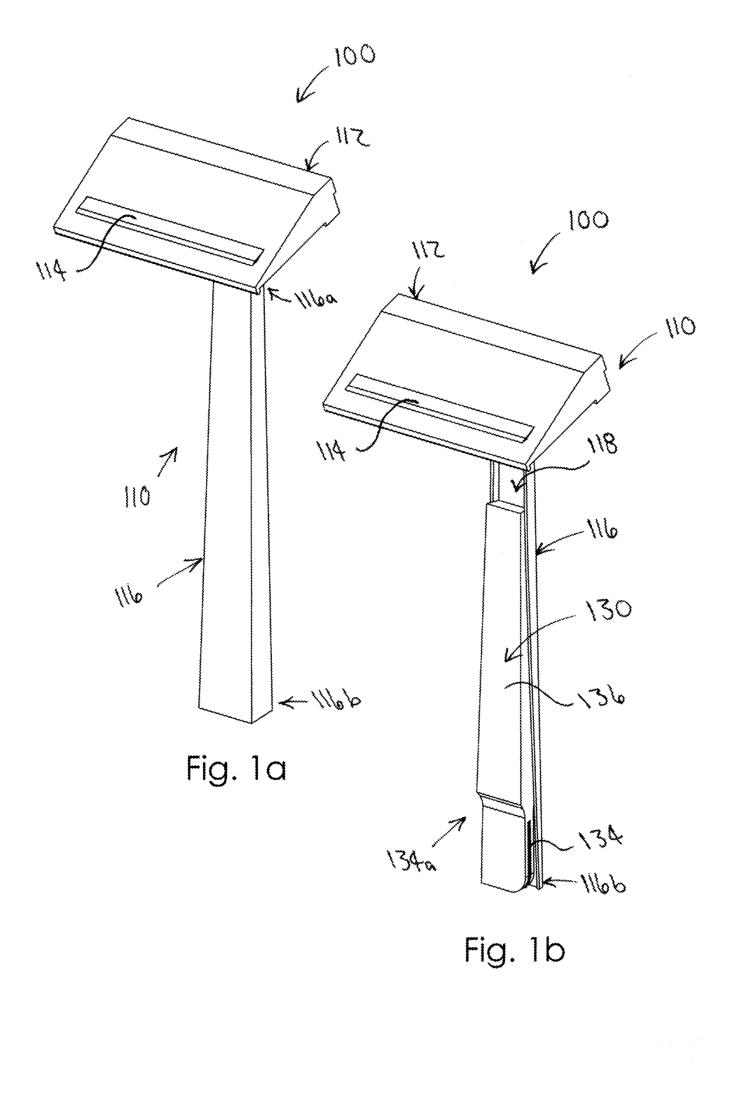

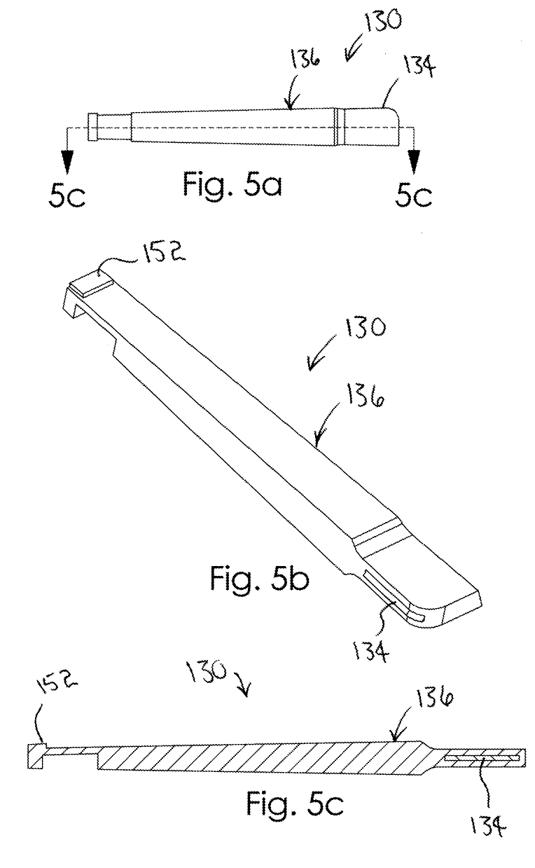

A personal razor device 100 according to the present invention will now be described in detail with reference to FIGS. 1a through 7b of the accompanying drawings. More particularly, according to the current invention, a personal razor device 100 includes a primary cutter 110 and an auxiliary cutter 130.

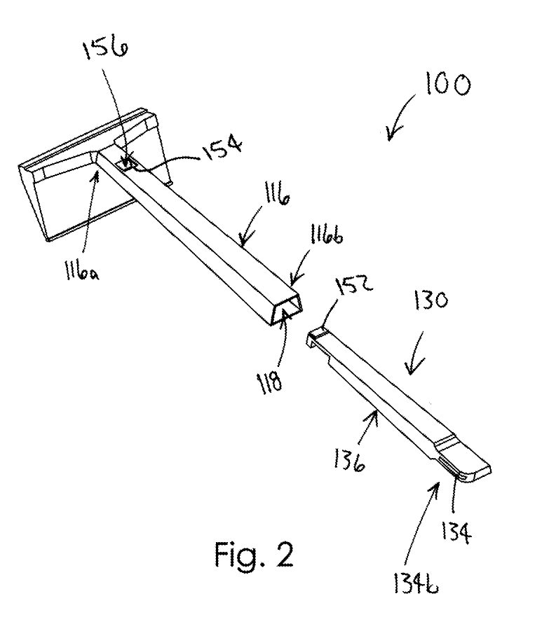

As shown in FIG. 1a through FIG. 3, for example, the primary cutter 110 has a primary cutting head 112. A primary cutting member 114 is coupled to the primary cutting head 112, and a primary handle 116 is coupled to the primary cutting head 112. More particularly, the primary handle 116 has first and second opposed ends 116a, 116b, and the primary handle first end 116a is coupled to the primary cutting head 112. As shown throughout the drawings, the primary handle 116 may extend generally perpendicular to the primary cutting head 112, and the primary cutting member 114 may be a safety razor. The primary handle 116 may include a hollow cavity 118 extending from the second end 116b toward the first end 116a, as shown in FIGS. 2, 3, 4b, 6, and 7a, for example.

As shown in FIGS. 1b, 2, 3, 4b, and 5a-7b, the auxiliary cutter 130 has an auxiliary cutting member 134 coupled to an auxiliary handle 136. The auxiliary cutting member 134 may be a razor blade disposed along at least one side 136a of the auxiliary handle 136, or in other words, a straight razor. It should be understood that the term “straight razor” used herein does not require the razor to be linear, but rather refers to a classic cutting implement predating safety razors.

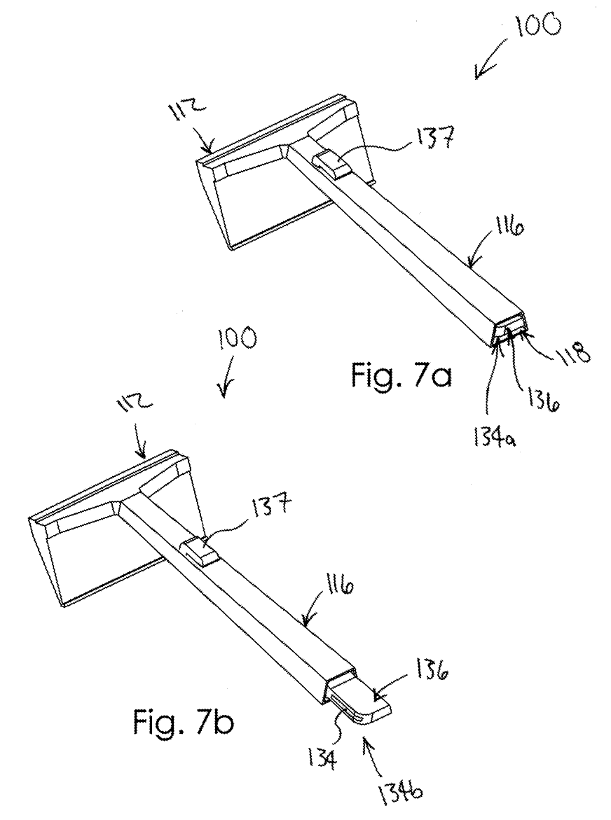

The auxiliary cutting member 134 is movable between a first configuration 134a (FIGS. 1b, 4b, and 7a) in which the auxiliary cutting member 134 is disposed inside the primary handle 116 (i.e., inside the hollow cavity 118) and a second configuration 134b (FIGS. 2, 3, 6, and 7b) in which the auxiliary cutting member 134 is outside the primary handle 116. The auxiliary handle 136 may be removably coupled to the primary handle 116 (FIGS. 1b-3, 4b-4d, and 5b-6,) or the auxiliary handle 136 may be slidably coupled to the primary handle 116 (FIGS. 7a and 7b).

If the auxiliary handle 136 is removably coupled to the primary handle 116, the auxiliary cutting member 134 may be inside the primary handle 116 (i.e., inside the hollow cavity 118) when the auxiliary handle 136 is coupled to the primary handle 116 (i.e., when at the first configuration 134a) and outside the primary handle 116 (i.e., outside the hollow cavity 118) when the auxiliary handle 136 is separated from the primary handle 116 (i.e., when at the second configuration 134b). In the embodiments shown in FIGS. 1 through 5c, the auxiliary handle 136 may additionally be disposed inside the primary handle 116 (i.e., inside the hollow cavity 118) when the auxiliary handle 136 is coupled to the primary handle 116. Either the primary handle 116 or the auxiliary handle 136 may include a protrusion 152, and the other (i.e., the auxiliary handle 136 or the primary handle 116) may include a receiving element 154 (also referred to herein as a “receiving wall”) having a configuration complementary to the protrusion 152.

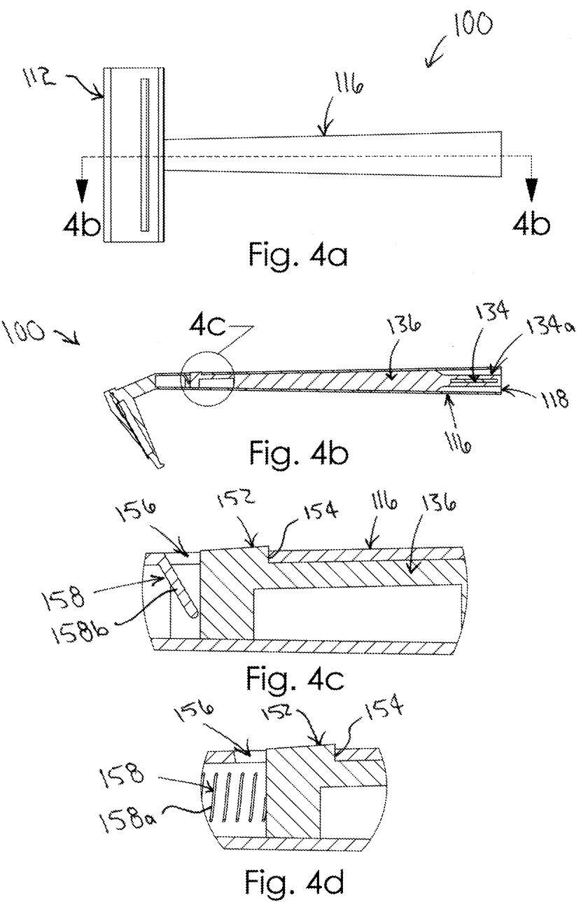

As shown in FIGS. 4c and 4d, interaction between the protrusion 152 and the receiving element 154 may selectively couple the auxiliary handle 136 to the primary handle 116. If the primary handle 116 includes the receiving element 154, the primary handle 116 may also define an aperture 156 adjacent the receiving element 154. The protrusion 152 may be accessible at the aperture 156 when the protrusion 152 and the receiving element 154 interact to separate the auxiliary handle 136 and the primary handle 116. A biasing member 158 (e.g., a spring 158a as shown in FIG. 4d, a resilient portion 158b of the primary handle 116 as shown in FIG. 4c, etc.) may force the auxiliary handle 136 out of the primary handle 116 when the auxiliary handle 136 is inside the primary handle 116 and the protrusion 152 is not interacting with the receiving element 154.

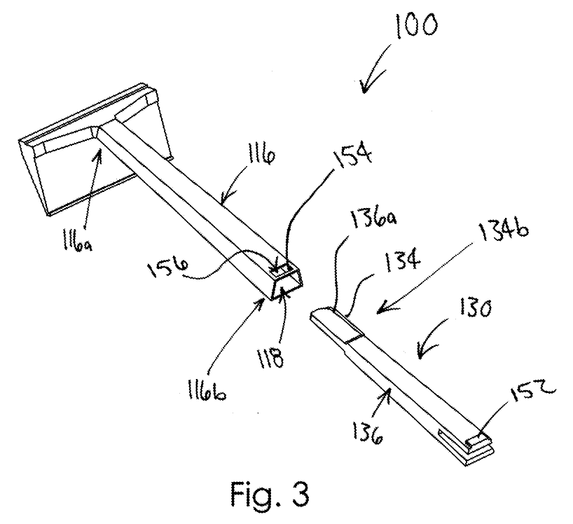

The protrusion 152 and receiving element 154 may be configured so that the auxiliary cutting member 134 is generally adjacent the primary handle second end 116b (FIGS. 1b and 2), or may alternately be configured so that the auxiliary cutting member 134 is generally adjacent the primary handle first end 116a (FIG. 3). Placing the auxiliary cutting member 134 adjacent the first end 116a may be advantageous in ensuring that the auxiliary cutting member 134 does not accidentally cut a user, either while inside the primary handle 116 or while being removed from the primary handle 116. Placing the auxiliary cutting member 134 adjacent the second end 116b may be advantageous in ensuring that the auxiliary cutting member 134 dries properly, for example.

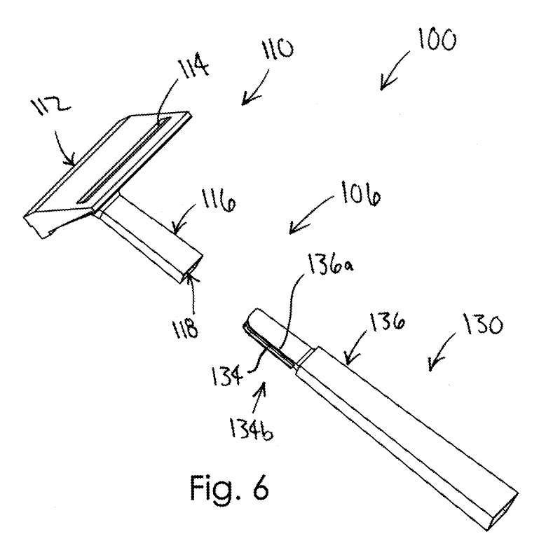

In the embodiment shown in FIG. 6, the auxiliary handle 136 and the primary handle 116 are removably coupled and the auxiliary cutting member 134 may be inside the primary handle 116 as set forth above, but the auxiliary handle 136 is not disposed inside the primary handle 116. Instead, the primary handle 116 and the auxiliary handle 136 collectively define a unitary handle 106 when the auxiliary handle 136 is coupled to the primary handle 116. In other words, a portion of the length of the unitary handle 106 is defined by the primary handle 116, and a portion of the length of the unitary handle 106 is defined by the auxiliary handle 136.

FIGS. 7a and 7b show an embodiment of the current invention in which the auxiliary cutting member 134 is movable between the first and second configurations 134a, 134b and the auxiliary handle 136 is slidably coupled to the primary handle 116 as noted above. The auxiliary handle 136 shown in FIGS. 7a and 7b is positioned inside the primary handle 116 and has a pushplate 137 extending outside the primary handle 116. The pushplate 137 may be used to selectively slide the auxiliary handle 136 relative to the primary handle 116 to move the auxiliary cutting member 134 between the first and second configurations 134a, 134b.

In use, the user may shave larger areas (e.g., cheeks, neck, etc.) with the primary cutting member 114 in a conventional manner. To shave smaller, intricate areas (e.g., between the nose and upper lip, etc.), the user may alternately shave with the auxiliary cutting member 134. More particularly, the user may move the auxiliary cutting member 134 from the first configuration 134a (FIGS. 1b, 4b-4d, and 7a) in which the auxiliary cutting member 134 is disposed inside the primary handle 116 (i.e., inside the hollow cavity 118) to the second configuration 134b (FIGS. 2, 3, 6, and 7b) in which the auxiliary cutting member 134 is outside the primary handle 116. As discussed above, this may be accomplished by overcoming the interaction between the protrusion 152 and the receiving element 154 (FIGS. 1a-5c), separating the primary and auxiliary handles 116, 136 (FIG. 6), or sliding the auxiliary handle 136 relative to the primary handle 116 (FIGS. 7a, 7b). Once the user is finished using the auxiliary cutting member 134, the auxiliary cutting member may be returned to the first configuration 134a.

It is understood that while certain forms of this invention have been illustrated and described, it is not limited thereto except insofar as such limitations are included in the following claims and allowable functional equivalents thereof.

1. A personal razor device, comprising:
a primary cutting head having a primary cutting member;
a primary handle having one end coupled to said primary cutting head;
an auxiliary cutting member; and
an auxiliary handle coupled to said auxiliary cutting member and removably coupled to said primary handle.

2. The personal razor device as in claim 1, wherein said auxiliary cutting member is a razor blade disposed along at least one side of said auxiliary handle.

3. The personal razor device as in claim 1, wherein said primary cutting member is a safety razor and said auxiliary cutting member is a straight razor.

4. The personal razor device as in claim 1, wherein:
one of said primary handle and said auxiliary handle includes a protrusion;
another of said primary handle and said auxiliary handle includes a receiving wall having a configuration complementary to said protrusion;
interaction between said protrusion and said receiving wall selectively couples said auxiliary handle to said primary handle; and
said auxiliary cutting member is disposed inside said primary handle when said auxiliary handle is coupled to said primary handle.

5. The personal razor device as in claim 4, wherein:
said auxiliary handle is disposed inside said primary handle when said auxiliary handle is coupled to said primary handle;
said auxiliary handle includes said protrusion;
said primary handle includes said receiving wall;
said receiving wall is adjacent an aperture in said primary handle;
said protrusion is accessible at said aperture when said protrusion and said receiving wall interact for separating said auxiliary handle and said primary handle.

6. The personal razor device as in claim 5, further comprising a biasing member to force said auxiliary handle out of said primary handle when said auxiliary handle is inside said primary handle and said protrusion is not interacting with said receiving wall.

7. The personal razor device as in claim 6, wherein:
said primary cutting member is a safety razor; and
said auxiliary cutting member is a razor blade disposed along at least one side of said auxiliary handle.

8. The personal razor device as in claim 1, wherein:
said primary cutting head is generally perpendicular to said primary handle;
said primary handle defines a cavity for receiving said auxiliary cutting member when said auxiliary handle is coupled to said primary handle; and
said primary handle and said auxiliary handle collectively define a unitary handle when said auxiliary handle is coupled to said primary handle.

9. A personal razor device, comprising:
a primary cutter having a primary cutting head, a primary cutting member coupled to said primary cutting head, and a primary handle having first and second opposed ends, said first primary handle end being coupled to said primary cutting head, said primary handle including a hollow cavity extending from said second end toward said first end; and
an auxiliary cutter having an auxiliary cutting member and an auxiliary handle, said auxiliary handle being coupled to said auxiliary cutting member;
wherein said auxiliary handle is removably coupled to said primary handle;
wherein said auxiliary cutting member is inside said hollow cavity when said auxiliary handle is coupled to said primary handle; and
wherein said auxiliary cutting member is outside said hollow cavity when said auxiliary handle is separated from said primary handle.

10. The personal razor device as in claim 9, wherein:
said primary cutting member is a safety razor; and
said auxiliary cutting member is a razor blade disposed along at least one side of said auxiliary handle.

11. The personal razor device as in claim 10, wherein:
one of said primary handle and said auxiliary handle includes a protrusion;
another of said primary handle and said auxiliary handle includes a receiving element having a configuration complementary to said protrusion;
interaction between said protrusion and said receiving element selectively couples said auxiliary handle to said primary handle; and
said auxiliary handle is disposed inside said hollow cavity when said auxiliary handle is coupled to said primary handle;

12. The personal razor device as in claim 11, wherein said protrusion and said receiving element are configured so that said auxiliary cutting member is generally adjacent said primary handle second end.

13. The personal razor device as in claim 11, wherein said protrusion and said receiving element are configured so that said auxiliary cutting member is generally adjacent said primary handle first end.

14. The personal razor device as in claim 11, further comprising a biasing member configured to force said auxiliary handle out of said hollow cavity when said auxiliary handle is inside said hollow cavity and said protrusion is not interacting with said receiving element.

15. The personal razor device as in claim 9, wherein:
said primary cutting head is generally perpendicular to said primary handle; and
said primary handle and said auxiliary handle collectively define a unitary handle when said auxiliary handle is coupled to said primary handle.

16. A personal razor device, comprising:
a primary cutter having a primary cutting head, a primary cutting member coupled to said primary cutting head, and a primary handle having opposed ends, one said primary handle end being coupled to said primary cutting head whereby said primary handle extends generally perpendicular to said primary cutting head; and
an auxiliary cutter having an auxiliary cutting member and an auxiliary handle, said auxiliary handle being coupled to said auxiliary cutting member;
wherein said auxiliary cutting member is movable between a first configuration in which said auxiliary cutting member is disposed inside said primary handle and a second configuration in which said auxiliary cutting member is outside said primary handle.

17. The personal razor device as in claim 16, wherein:
said auxiliary handle is removably coupled to said primary handle;
one of said primary handle and said auxiliary handle includes a protrusion;
another of said primary handle and said auxiliary handle includes a receiving element having a configuration complementary to said protrusion;
interaction between said protrusion and said receiving element selectively couples said auxiliary handle to said primary handle; and
said auxiliary handle is disposed inside said hollow cavity when said auxiliary handle is coupled to said primary handle.

18. The personal razor device as in claim 17, wherein:
said primary cutting member is a safety razor; and
said auxiliary cutting member is a razor blade disposed along at least one side of said auxiliary handle.

19. The personal razor device as in claim 16, wherein:
said auxiliary handle is positioned inside and slidably coupled to said primary handle;
said auxiliary handle has a pushplate extending outside said primary handle for selectively sliding said auxiliary handle relative to said primary handle to move said auxiliary cutting member between said first and second configurations.

20. The personal razor device as in claim 19, wherein:
said primary cutting member is a safety razor; and
said auxiliary cutting member is a razor blade disposed along at least one side of said auxiliary handle.
